(19) United States
(12) Patent Application Publication
(10) Pub. No.: US 2023/0394597 A1
(43) Pub. Date: Dec. 7, 2023

(54) SYSTEMS AND METHODS OF FACILITATING PROVISIONING OF AN IMPROVED FARMING ECOSYSTEM

(71) Applicant: Oliver Udeh, Loganville, GA (US)

(72) Inventor: Oliver Udeh, Loganville, GA (US)

(21) Appl. No.: 18/048,368

(22) Filed: Oct. 20, 2022

Related U.S. Application Data
(60) Provisional application No. 63/348,927, filed on Jun. 3, 2022.

(51) Int. Cl. G06Q 50/02; G06Q 40/08; G06Q 40/03

(52) U.S. Cl. CPC G06Q 50/02; G06Q 40/08; G06Q 40/03

(57) ABSTRACT

The present disclosure provides a method of facilitating provisioning of an improved farming ecosystem. Further, the method may include receiving, using a communication device, one or more IOT information from one or more farmer devices. Further, the method may include analyzing, using a processing device, the one or more IOT information. Further, the method may include generating, using the processing device, one or more research data based on the analyzing of the one or more IOT information. Further, the method may include storing, using a storage device, the one or more IOT information and the one or more research data in a distributed ledger and transmitting, using the communication device, the one or more research data to the one or more farmer devices.

The current application claims a priority to the U.S. provisional patent application Ser. No. 63/348,927 filed on Jun. 3, 2022.

### FIELD OF THE INVENTION

The present disclosure generally relates to data processing. More specifically, the present disclosure relates to systems and methods of facilitating provisioning of an improved farming ecosystem.

### BACKGROUND OF THE INVENTION

The field of data processing is technologically important to several industries, business organizations, and/or individuals.

Existing techniques of facilitating provisioning of an improved farming ecosystem are deficient in several ways. For instance, current technologies do not use Blockchain for data processing associated with agro-tech ecosystems. Tracking and monitoring farm produce using traditional technologies is cumbersome for the user and takes a lot of time. Further, it involves a lot of human error. Furthermore, current technologies do not track and monitor the quality standards of farm goods by updating information on distributed ledgers. Furthermore, current technologies do not process the farm produce and maintain the quality of farm produce up to a certain quality standard for export.

Therefore, there is a need for systems and methods of facilitating provisioning of an improved farming ecosystem that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of facilitating provisioning of an improved farming ecosystem. Further, the method may include receiving, using a communication device, one or more IOT information from one or more farmer devices associated with one or more farmers. Further, the method may include analyzing, using a processing device, the one or more IOT information. Further, the method may include generating, using the processing device, one or more research data based on the analyzing of the one or more IOT information. Further, the method may include storing, using a storage device, the one or more IOT information and the one or more research data in a distributed ledger and transmitting, using the communication device, the one or more research data to the one or more farmer devices.

The present disclosure provides a system for facilitating provisioning of an improved farming ecosystem. Further, the system may include a communication device. Further, the communication device may be configured for receiving one or more IOT information from one or more farmer devices associated with one or more farmers. Further, the communication device may be configured for transmitting one or more research data to the one or more farmer devices. Further, the system may include a processing device Further, the processing device may be configured for analyzing the one or more IOT information. Further, the processing device may be configured for generating the one or more research data based on analyzing of the one or more IOT information. Further, the system may include a storage device. Further, the storage device may be configured for storing the one or more IOT information and the one or more research data in a distributed ledger.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of facilitating provisioning of an improved farming ecosystem, in accordance with some embodiments.

FIG. 4A illustrates a flowchart of a method 400 of facilitating provisioning of an improved farming ecosystem, in accordance with some embodiments.

FIG. 4B illustrates a continuation of the flowchart of the method 400 of facilitating provisioning of an improved farming ecosystem, in accordance with some embodiments.

FIG. 5 illustrates a flowchart of a method 500 of facilitating provisioning of an improved farming ecosystem, in accordance with some embodiments.

FIG. 6 illustrates a flowchart of a method 600 of facilitating provisioning of an improved farming ecosystem, in accordance with some embodiments.

FIG. 7 illustrates a flowchart of a method 700 of facilitating provisioning of an improved farming ecosystem, in accordance with some embodiments.

FIG. 8 illustrates a flowchart of a method 800 of facilitating provisioning of an improved farming ecosystem, in accordance with some embodiments.

FIG. 9A illustrates a flowchart of a method 900 of facilitating provisioning of an improved farming ecosystem, in accordance with some embodiments.

FIG. 9B illustrates a continuation of the flowchart of the method 900 of facilitating provisioning of an improved farming ecosystem, in accordance with some embodiments.

FIG. 10A illustrates a flowchart of a method 1000 of facilitating provisioning of an improved farming ecosystem, in accordance with some embodiments.

FIG. 10B illustrates a continuation of the flowchart of the method 1000 of facilitating provisioning of an improved farming ecosystem, in accordance with some embodiments.

FIG. 11A illustrates a flowchart of a method 1100 of facilitating provisioning of an improved farming ecosystem, in accordance with some embodiments.

FIG. 11B illustrates a continuation of the flowchart of the method 1100 of facilitating provisioning of an improved farming ecosystem

FIG. 12 illustrates a block diagram of a system 1200 of facilitating provisioning of an improved farming ecosystem, in accordance with some embodiments.

FIG. 13 illustrates a block diagram of the system 1200 of facilitating provisioning of an improved farming ecosystem, in accordance with some embodiments.

FIG. 14 illustrates a flowchart of a method 1400 of facilitating provisioning of an improved farming ecosystem, in accordance with some embodiments.

FIG. 15 is a flowchart of a method 1500 for facilitating business operations associated with the 2FE agro-tech ecosystem, in accordance with some embodiments.

FIG. 16 illustrates the 2FE agro-tech ecosystem 1600, in accordance with some embodiments.

FIG. 17 is a flowchart of a method 1700 for tracking and monitoring at least one farm product associated with the 2FE agro-tech ecosystem, in accordance with some embodiments.

FIG. 18 illustrates an architecture of a system 1800 for facilitating provisioning of an improved farming ecosystem, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of facilitating provisioning of an improved farming ecosystem, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g., a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g., Windows, Mac OS, Unix, Linux, Android, etc.) in order to provide a user interface (e.g., GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g., username, password, passphrase, PIN, secret question, secret answer, etc.) and/or possession of a machine readable secret data (e.g., encryption key, decryption key, bar codes, etc.) and/or or possession of one or more embodied characteristics unique to the user (e.g., biometric variables such as, but not limited to, fingerprint, palm-print, voice characteristics, behavioral characteristics, facial features, iris pattern, heart rate variability, evoked potentials, brain waves, and so on) and/or possession of a unique device (e.g., a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g., transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g., the server computer, a client device, etc.) corresponding to the performance of the one or more steps, environmental variables (e.g., temperature, humidity, pressure, wind speed, lighting, sound, etc.) associated with a device corresponding to the performance of the one or more steps, physical state and/or physiological state and/or psychological state of the user, physical state (e.g., motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g., a real-time clock), a location sensor (e.g., a GPS receiver, a GLONASS receiver, an indoor location sensor, etc.), a biometric sensor (e.g., a fingerprint sensor), an environmental variable sensor (e.g., temperature sensor, humidity sensor, pressure sensor, etc.) and a device state sensor (e.g., a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g., initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure describes methods and systems of facilitating provisioning of an improved farming ecosystem. Further, a 2FE agro-tech ecosystem, an exemplary embodiment of the farming ecosystem provided by the disclosed system, may be configured to provide services to a plurality of farmers (or farmers) associated with the 2FE agro-tech ecosystem. Further, the disclosed system may be configured to make an off-takers arrangement with factories/industries to take farmer's farm produce. Further, the farmers may be supported with cutting-edge technologies to improve and manage farm inventory/records. Further, the disclosed system may support the farmers with technologies like IoT systems & drone technologies to improve & increase farm yields. Further, the disclosed system may support the farmers with research data & research information. Further, the disclosed system may support the farmers to get access to loans and business grants. Furthermore, blockchain technologies may be used to monitor/track farm produce and export transactions.

Further, the 2FE agro-tech ecosystem may provide services to the factories. Further, the disclosed system may connect the factories (or industries) to a source of raw material for production. Further, the disclosed system may be configured to deliver raw materials directly to the factories. Further, the disclosed system may create a global e-commerce market store. Further, the disclosed system may advertise and promote finished products of the factories through digital marketing tools. Further, the disclosed system may be configured to facilitate loans/business grants with funding partners and agencies to improve production. Further, the factories may be helped with research data and information.

Further, the disclosed system may provide a plurality of services to logistic companies. Further, upon using the disclosed system, various logistics companies may be engaged in the delivery of goods (or farm produce) to the industries. Further, the goods in transit may be monitored, tracked, and managed from the source down to the destination by using the disclosed system. Further, the disclosed system may manage and insure the goods in transit.

Further, the disclosed system may include processing centers. Further, the farm produce may be cleaned and re-packaged for export in the processing centers. Further, the perishable goods may be preserved and managed in the processing centers, wherein QA/QC department associated with the disclosed system oversees the quality/condition of goods before delivery to the destination. Further, the disclosed system may be configured for processing/preparing a farm produce and assuring the quality of the farm produce upto a certain quality standard for export.

Further, the disclosed system may work closely with insurance institutions in making sure all goods are adequately insured and manage all insurance claims that may arise.

Further, all the registered farms may be migrated into the 2FE agro-tech ecosystem via a farmers' association. Further, the disclosed system may be configured for liaising with the farmers' association to improve the farm produce. Further, the disclosed system may provide or communicate research information to farmers through the farmers' association. Further, the farmers' association may be provided with a business grant/loan accessible to information associated with farmers.

Further, the disclosed system may work with internal and external research centers to improve the operations of farms and factories by providing research data, research results, recommendations to farmers/factories via the farmers' association, and assistance in implementing research recommendations.

Further, the global e-commerce store provided by the disclosed system may serve as the hub to advertise/promote and sell the factories' finished products globally like the services provided by Amazon™.

Further, the disclosed system may be linked up with global funding partners/agencies to facilitate managing all loan portfolios, especially repayment plans and collections services on behalf of the agencies.

Further, the disclosed system may deploy several cutting-edge technologies to manage the entire agricultural supply chain system to assist farmers in improving farms' operation using technologies that may include blockchain technologies to store/track the conditions of goods. Further, 2FE ERP system, an exemplary embodiment of an administrative software associated with the disclosed system, may manage the entire global e-commerce website. Further, the disclosed system may provide a global market hub to showcase and sells the finished products of the factories. Further, the disclosed system may provide IoT systems & drones to assist the farmers in performing farm operations. Further, mobile applications associated with the disclosed system on the iOS and Android may be available for transactions and tracking operations.

Further, various processes performed by the disclosed system may require man power. Further, millions of people may be engaged in employment throughout a supply chain system associated with the disclosed system.

Further, the disclosed system may enable 2FE SMART FARMING that may be an IoT solution. Further, objectives associated with the 2FE IOT solution may include cost management and waste reduction. Further, the disclosed system may be configured to mitigate against low production risks. Further, the disclosed system may be configured to provide enhanced product quality and volumes. Further, the disclosed system may be configured to increase business efficiency through process automation. Further, the disclosed system may ensure farmers get high revenue. Further, the disclosed system aims to use IOT Devices, UAV Drones, and AI models as part of our “Agro-Tech Ecosystem” initiative amongst others to optimize farm operations and Management in the following ways. Further, the disclosed system installs and uses IoT devices and sensors to collect farm data from the farms. Further, the farm data may include weather condition data, soil quality/condition data, crop growth progress data, temperature, humidity, lighting information, erosion data, floods data, crop data, animal diseases data, disaster data, etc. Further, the data collected may be used by the data science/research department associated with the disclosed system. Further, the insights drawn from the data may be provided to farmers to improve their farming methods. The data may also be used to train machine and deep learning models (AI models) in order to automate. Further, the disclosed system places every information the farmers need on their application dashboard with powerful visualization in real-time. This information now serves as a reference guide in their daily farm operations. Further, the disclosed system may provide a general IoT solution that leverages worldwide farm information/data. Further, the disclosed system may provide a custom-tailored IoT solution that leverages specific farm data for data analytics and automation, in order to deal with a specific farm problem rather than using general farm data. Further, the disclosed system may follow a low-level approach where 2FE aims to understand each farm's specific problems and provide the solution accordingly.

Further, the disclosed system may be configured to obtain data from different parts of the world. Further, the disclosed system may be configured to send the data to the Data Science/Research department. Further, the disclosed system may be configured to classify data based on region/location. Further, the disclosed system may be configured to explain data by a data domain expert explains (Agricultural scientist). Further, data engineers may clean and process the data. Further, the data analyst may analyze the data and give insight to farmers and stakeholders. Further, an AI engineer builds and deploys ML & DL models. Further, application developers may create mobile & web apps for farmers to interface and obtain farming information/guidelines from the AI models. Further, the farmers may implement the various advice, methods and warnings, etc. obtained from the artificial intelligence model.

Further, in some embodiments, the disclosed system may install IoT monitoring system/sensors on the farm if not present. Further, the disclosed system may obtain data (such as temperature, humidity, etc.). Further, the disclosed system sends the data to the Data Science/Research department. Further, a data domain expert explains the data. Further, data engineers may clean and process the data. Further, a data analyst may analyze the data and give an insight into the farmers. Further, an AI engineer may build and deploy ML & DL models. Further, application developers may create mobile & web apps for farmers to interface and obtain farming information/guidelines from the AI models. Further, the farmers may implement the various advice, methods, warnings, etc. obtained from the artificial intelligence model.

Further, the disclosed system may guide the farmers on when to plant and harvest. Further, the disclosed system may help in resource control and optimization. Further, the disclosed system may allow the farmers to access predictive analysis/forecast reports on their desks. Further, the disclosed system may reduce wastage. Further, the disclosed system may be configured for cost management.

Further, the disclosed system may be configured to optimize the entire agricultural food supply chain system globally. Further, the focus of the system may be on raw materials and packaged/processed food. Further, the disclosed system may be configured to ascertain the actual condition of every produce/product from the farms. Further, the disclosed system may be configured to ensure food safety: food contamination, product expiration, etc. Further, the disclosed system may be configured to establish transparency and trust amongst stakeholders and consumers. Further, the disclosed system may be configured to detect counterfeit/fake products. Further, the disclosed system may be configured to trace the origin of any produce. Further, the disclosed system may be configured to create a blockchain system on the Ethereum networks using Ethereum smart contracts. Further, the disclosed system may be configured to create a web platform for farmers to use for data inputs and interact with the blockchain system. Further, data may be published on the blockchain after record consensus by approved food safety agencies worldwide and other regulatory bodies. Further, the disclosed system may be configured to create a mobile app with a QR code/barcode functionality for end users/customers to use to scan and obtain product information.

Further, the disclosed system may provide a 2FE social media platform. Further, the 2FE social media platform may connect targeted individuals in an agro-tech supply chain. Further, the 2FE social media platform may operate like (Twitter™ or Facebook™) but it's sector base social media platform that may connect and reach out to the targeted individuals or audience in the Agro-allied sectors.

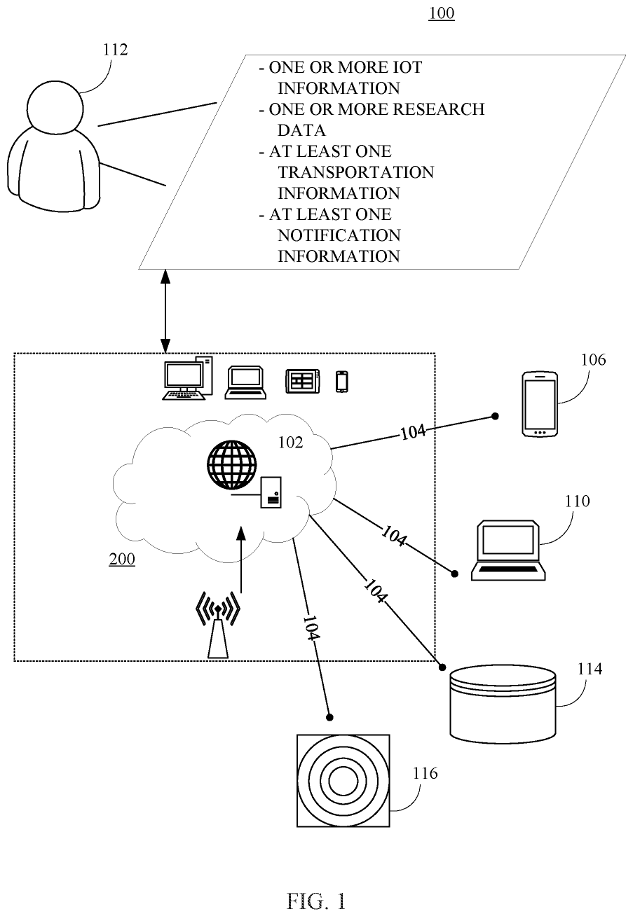

FIG. 1 is an illustration of an online platform 100 consistent with various embodiments of the present disclosure. By way of non-limiting example, the online platform 100 to enable facilitating provisioning of an improved farming ecosystem may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, farmers, farm factory owners, administrators, and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 200.

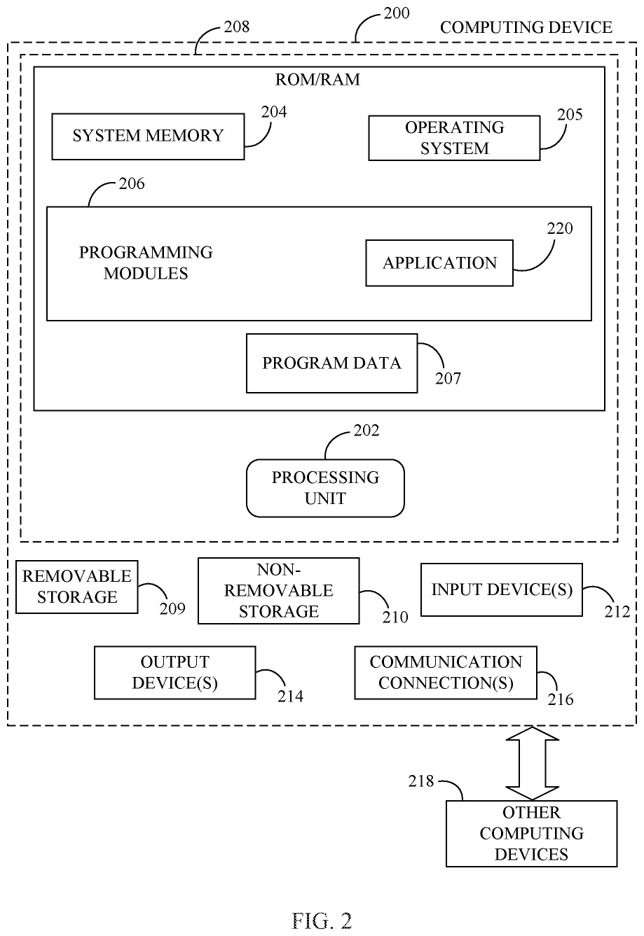

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g., random-access memory (RAM)), non-volatile (e.g., read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

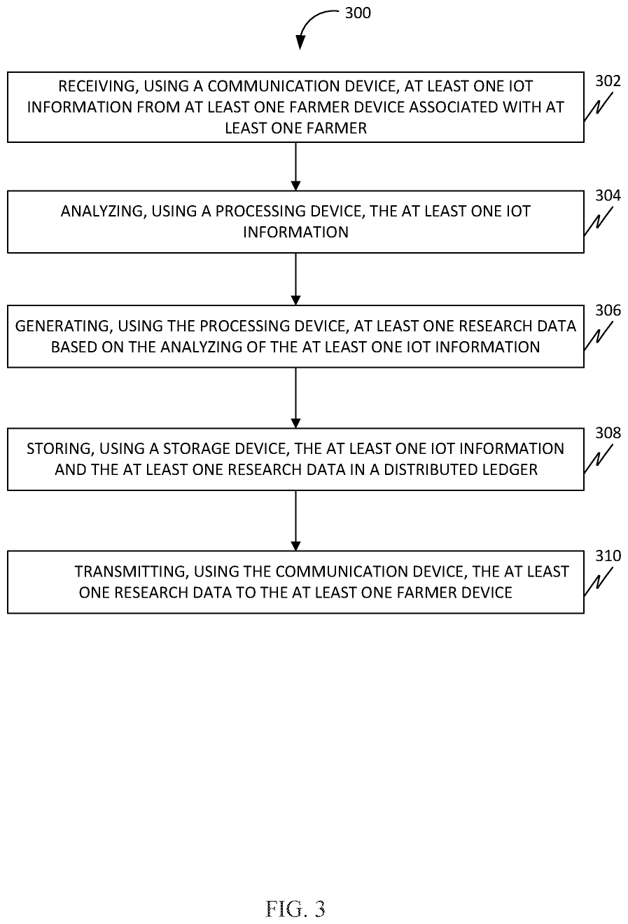

FIG. 3 illustrates a flowchart of a method 300 of facilitating provisioning of an improved farming ecosystem, in accordance with some embodiments.

Accordingly, the method 300 may include a step 302 of receiving, using a communication device 1202, one or more IOT information from one or more farmer devices (such as one or more farmer devices 1302) associated with one or more farmers. Further, the method 300 may include a step 304 of analyzing, using a processing device 1204, the one or more IOT information. Further, the method 300 may include a step 306 of generating, using the processing device 1204, one or more research data based on the analyzing of the one or more IOT information. Further, the method 300 may include a step 308 of storing, using a storage device 1206, the one or more IOT information and the one or more research data in a distributed ledger. Further, the method 300 may include a step 310 of transmitting, using the communication device 1202, the one or more research data to the one or more farmer devices.

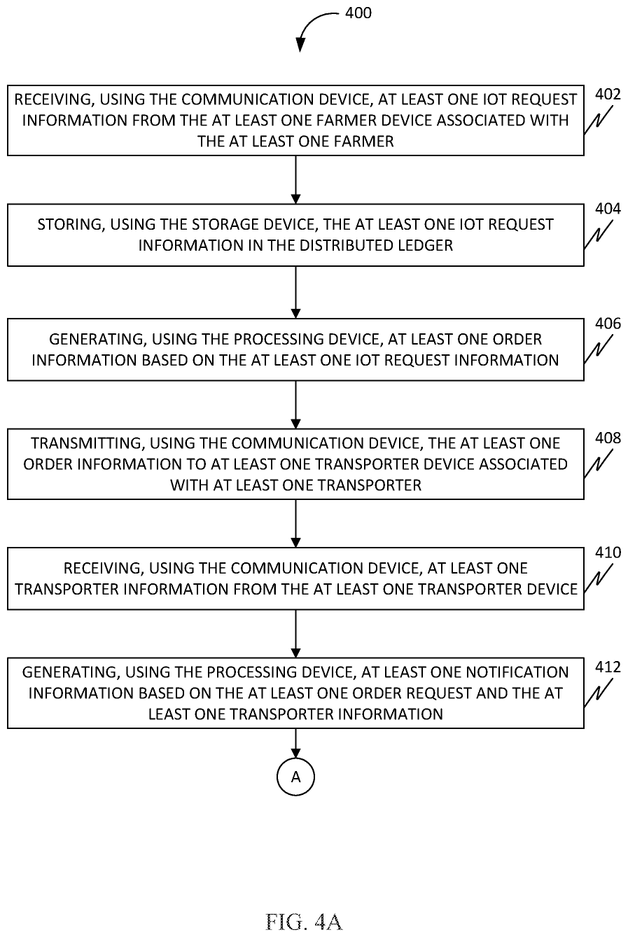

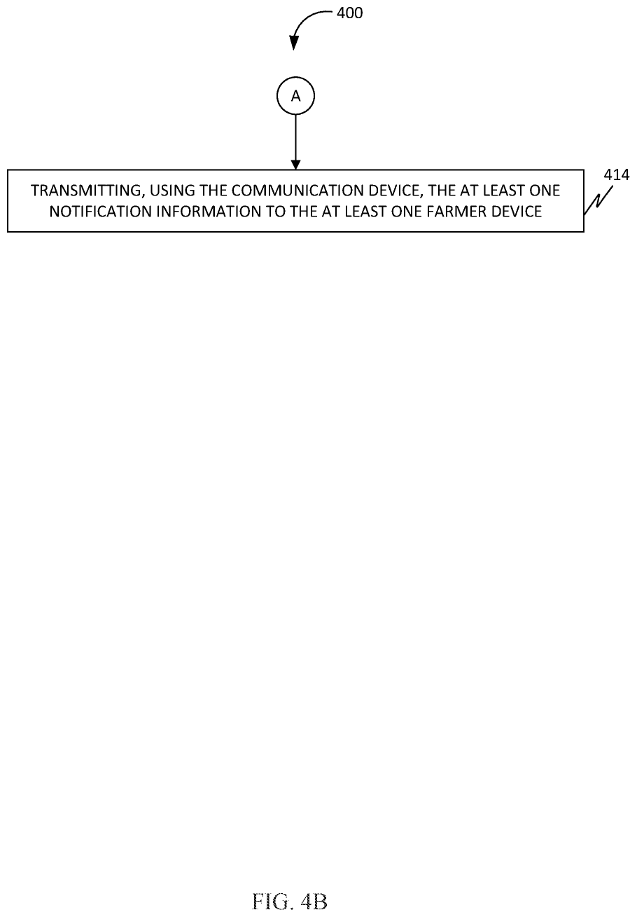

FIG. 4A and FIG. 4B illustrate a flowchart of a method 400 of facilitating provisioning of an improved farming ecosystem, in accordance with some embodiments.

Further, the method 400 may include a step 402 of receiving, using the communication device 1202, one or more IOT request information from the one or more farmer devices associated with the one or more farmers.

Further, the method 400 may include a step 404 of storing, using the storage device 1206, the one or more IOT request information in the distributed ledger.

Further, the method 400 may include a step 406 of generating, using the processing device 1204, one or more order information based on the one or more IOT request information.

Further, the method 400 may include a step 408 of transmitting, using the communication device 1202, the one or more order information to one or more transporter devices (such as at least one transporter device 1308) associated with one or more transporters.

Further, the method 400 may include a step 410 of receiving, using the communication device 1202, one or more transporter information from the one or more transporter devices.

Further, the method 400 may include a step 412 of generating, using the processing device 1204, one or more notification information based on the one or more order requests and the one or more transporter information.

Further, the method 400 may include a step 414 of transmitting, using the communication device 1202, the one or more notification information to the one or more farmer devices.

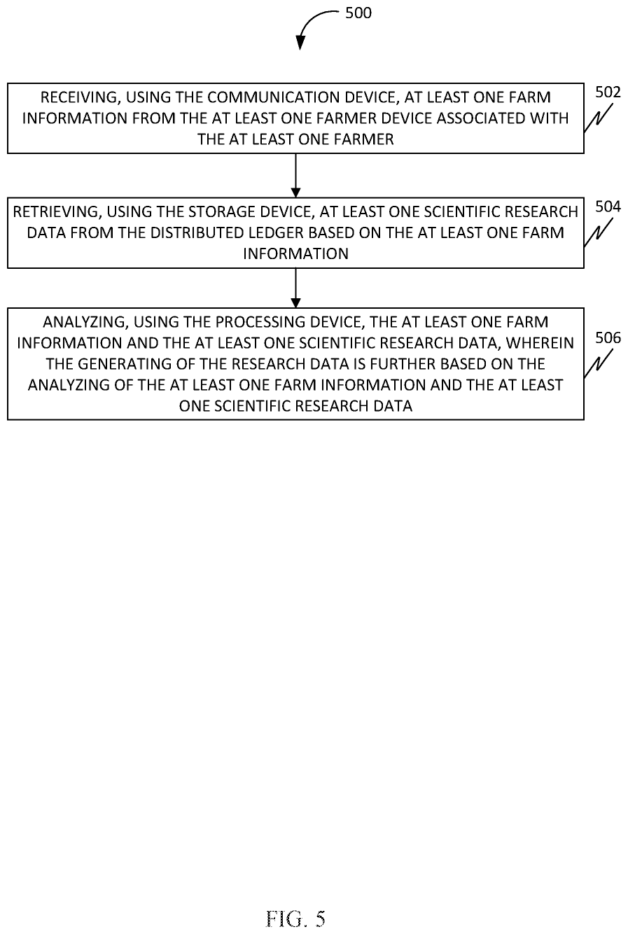

FIG. 5 illustrates a flowchart of a method 500 of facilitating provisioning of an improved farming ecosystem, in accordance with some embodiments.

Further, the method 500 may include a step 502 of receiving, using the communication device 1202, one or more farm information from the one or more farmer devices associated with the one or more farmers.

Further, the method 500 may include a step 504 of retrieving, using the storage device 1206, one or more scientific research data from the distributed ledger based on the one or more farm information.

Further, the method 500 may include a step 506 of analyzing, using the processing device 1204, the one or more farm information and the one or more scientific research data. Further, the generating of the research data may be based on the analyzing of the one or more farm information and the one or more scientific research data.

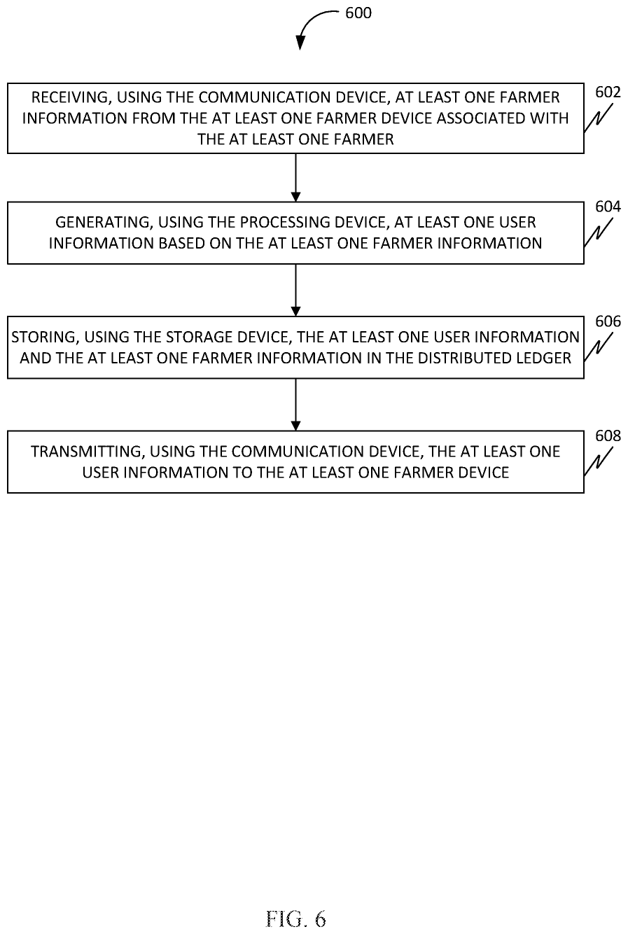

FIG. 6 illustrates a flowchart of a method 600 of facilitating provisioning of an improved farming ecosystem, in accordance with some embodiments.

Further, the method 600 may include a step 602 of receiving, using the communication device 1202, one or more farmer information from the one or more farmer devices associated with the one or more farmers.

Further, the method 600 may include a step 604 of generating, using the processing device 1204, one or more user information based on the one or more farmer information.

Further, the method 600 may include a step 606 of storing, using the storage device 1206, the one or more user information and the one or more farmer information in the distributed ledger.

Further, the method 600 may include a step 608 of transmitting, using the communication device 1202, the one or more user information to the one or more farmer devices.

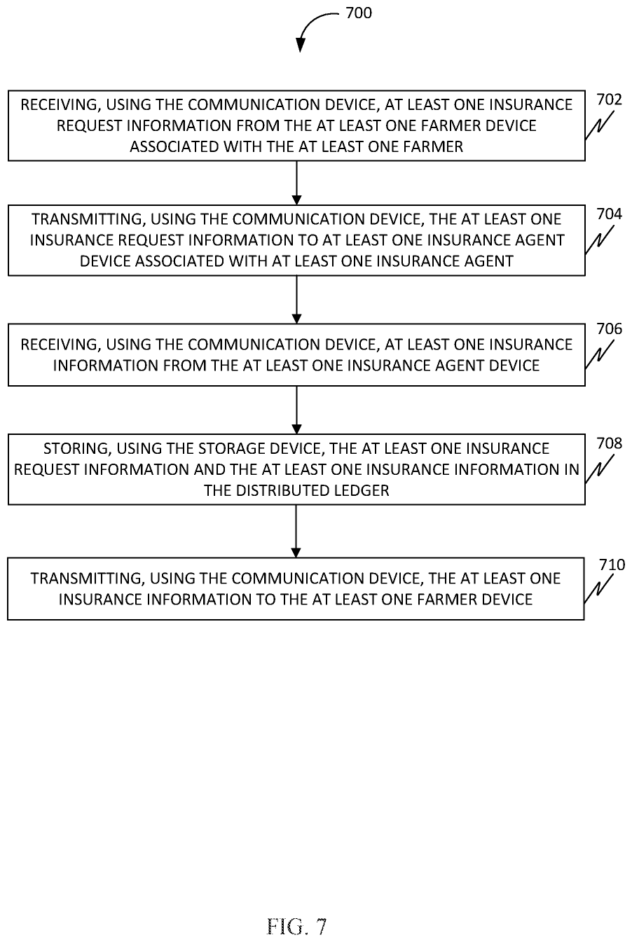

FIG. 7 illustrates a flowchart of a method 700 of facilitating provisioning of an improved farming ecosystem, in accordance with some embodiments.

Further, the method 700 may include a step 702 of receiving, using the communication device 1202, one or more insurance request information from the one or more farmer devices associated with the one or more farmers.

Further, the method 700 may include a step 704 of transmitting, using the communication device 1202, the one or more insurance requests to one or more insurance agent devices (such as one or more insurance agent devices 1304) associated with one or more insurance agents.

Further, the method 700 may include a step 706 of receiving, using the communication device 1202, one or more insurance information from the one or more insurance agent devices.

Further, the method 700 may include a step 708 of storing, using the storage device 1206, the one or more insurance request information and the one or more insurance information in the distributed ledger.

Further, the method 700 may include a step 710 of transmitting, using the communication device, the one or more insurance information to the one or more farmer device.

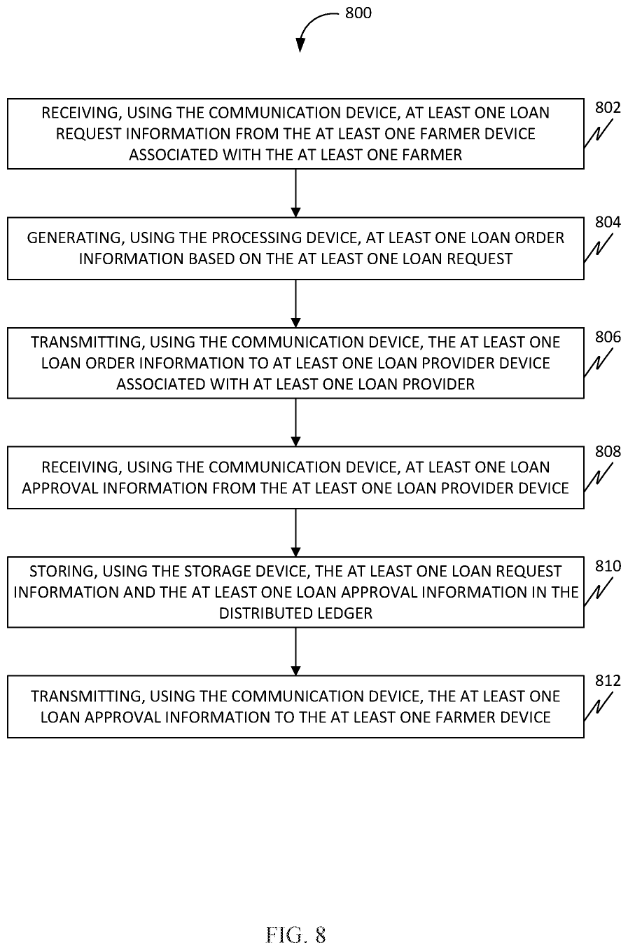

FIG. 8 illustrates a flowchart of a method 800 of facilitating provisioning of an improved farming ecosystem, in accordance with some embodiments.

Further, the method 800 may include a step 802 of receiving, using the communication device 1202, one or more loan request information from the one or more farmer devices associated with the one or more farmers.

Further, the method 800 may include a step 804 of generating, using the processing device 1204, one or more loan order information based on the one or more loan requests.

Further, the method 800 may include a step 806 of transmitting, using the communication device 1202, the one or more loan order information to one or more loan provider devices (such as one or more loan provider devices 1306) associated with one or more loan providers.

Further, the method 800 may include a step 808 of receiving, using the communication device 1202, one or more loan approval information from the one or more loan provider devices.

Further, the method 800 may include a step 810 of storing, using the storage device 1206, the one or more loan request information and the one or more loan approval information in the distributed ledger.

Further, the method 800 may include a step 812 of transmitting, using the communication device 1202, the at least one loan approval information to the one or more farmer devices.

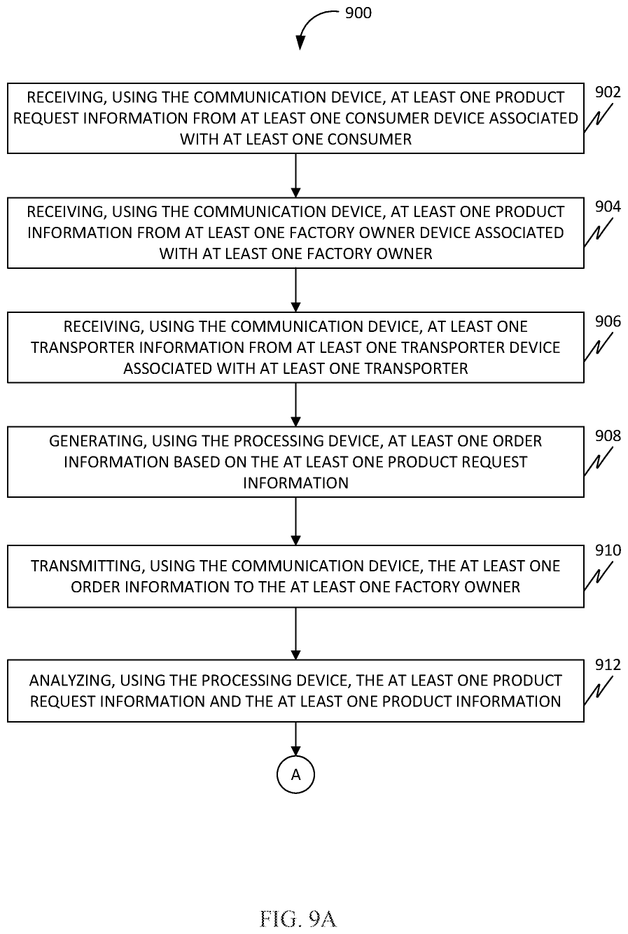

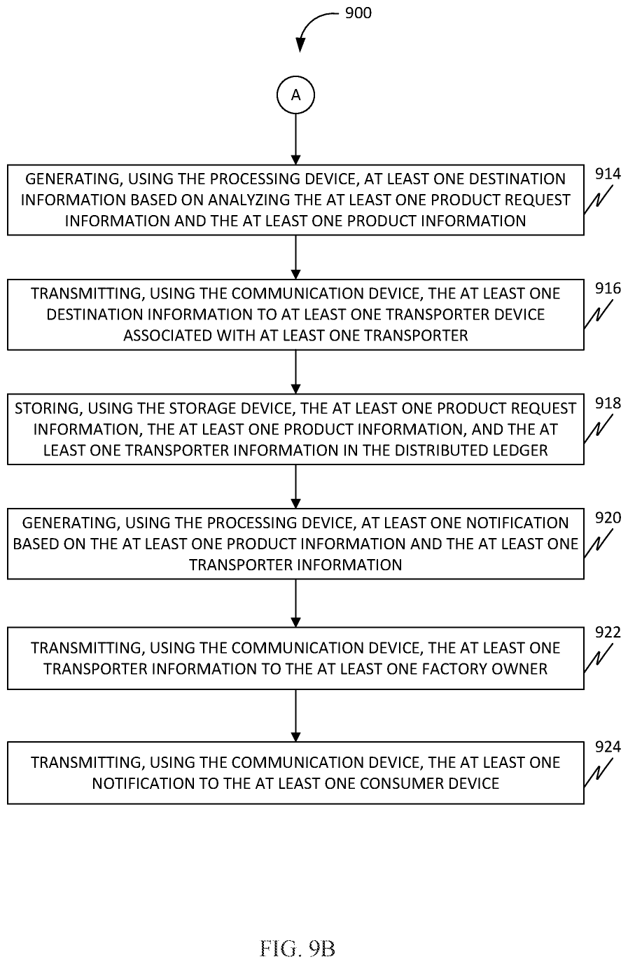

FIG. 9A and FIG. 9B illustrate a flowchart of a method 900 of facilitating provisioning of an improved farming ecosystem, in accordance with some embodiments.

Further, the method 900 may include a step 902 of receiving, using the communication device 1202, one or more product request information from one or more consumer devices (such as one or more consumer devices 1312) associated with one or more consumers.

Further, the method 900 may include a step 904 of receiving, using the communication device 1202, one or more product information from one or more factory owner devices (such as one or more factory owner devices 1310) associated with at least one factory owner.

Further, the method 900 may include a step 906 of receiving, using the communication device 1202, one or more transporter information from one or more transporter devices associated with one or more transporters.

Further, the method 900 may include a step 908 of generating, using the processing device 1204, one or more order information based on the one or more product request information.

Further, the method 900 may include a step 910 of transmitting, using the communication device 1202, the one or more order information to the one or more factory owner devices.

Further, the method 900 may include a step 912 of analyzing, using the processing device 1204, the one or more product request information and the one or more product information.

Further, the method 900 may include a step 914 of generating, using the processing device 1204, one or more destination information based on analyzing the one or more product request information and the one or more product information.

Further, the method 900 may include a step 916 of transmitting, using the communication device 1202, the one or more destination information to one or more transporter devices associated with one or more transporters.

Further, the method 900 may include a step 918 of storing, using the storage device 1206, the one or more product request information, the one or more product information, and the one or more transporter information in the distributed ledger.

Further, the method 900 may include a step 920 of generating, using the processing device 1204, one or more notifications based on the one or more product information and the one or more transporter information.

Further, the method 900 may include a step 922 of transmitting, using the communication device 1202, the one or more transporter information to the one or more factory owner devices.

Further, the method 900 may include a step 924 of transmitting, using the communication device 1202, the one or more notifications to the one or more consumer devices.

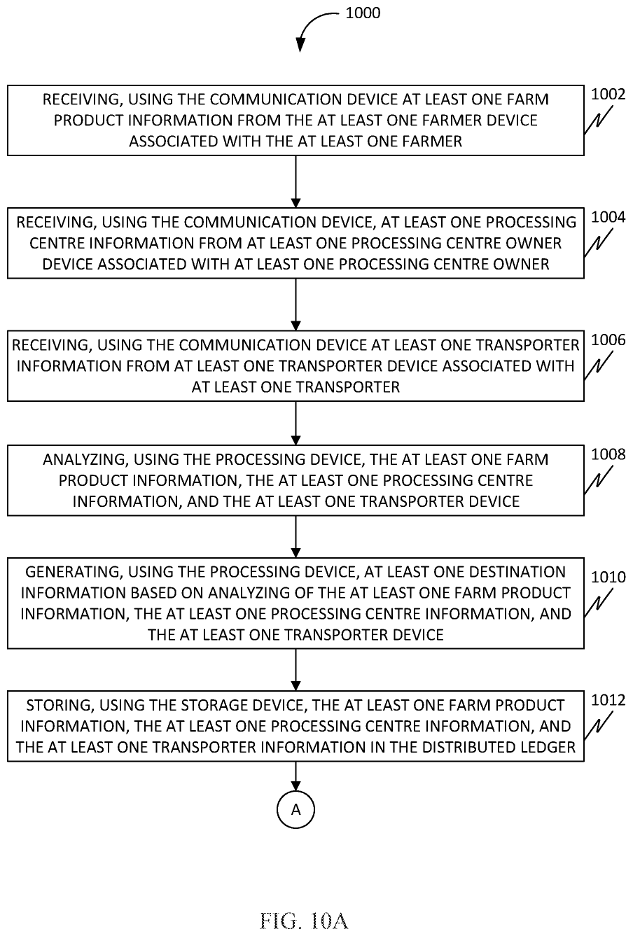

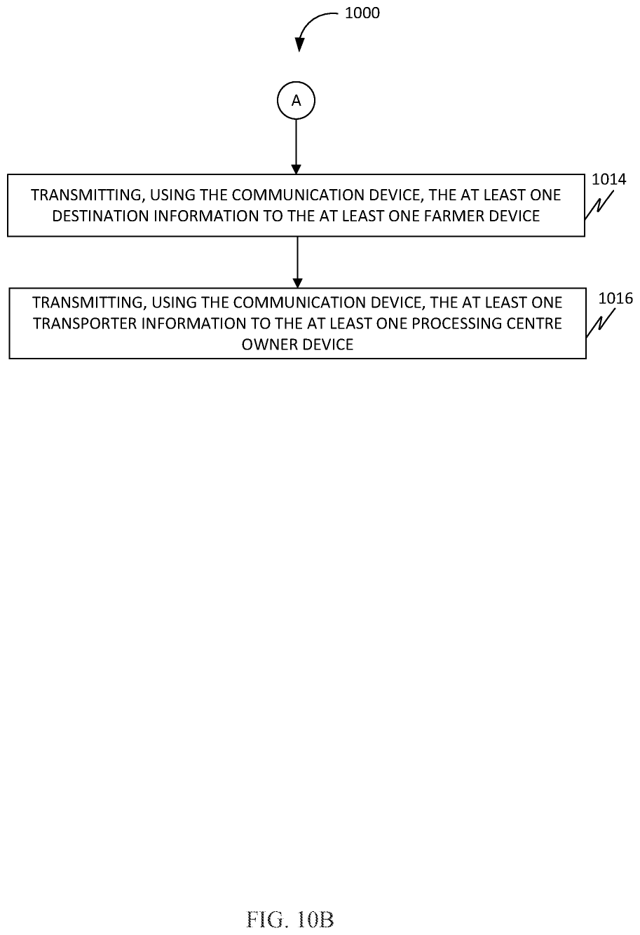

FIG. 10A and FIG. 10B illustrate a flowchart of a method 1000 of facilitating provisioning of an improved farming ecosystem, in accordance with some embodiments.

Further, the method 1000 may include a step 1002 of receiving, using the communication device 1202, one or more farm product information from the one or more farmer devices associated with the one or more farmers.

Further, the method 1000 may include a step 1004 of receiving, using the communication device 1202, one or more processing centre information from one or more processing centre owner devices (such as one or more processing centre owner devices 1314) associated with one or more processing centre owners.

Further, the method 1000 may include a step 1006 of receiving, using the communication device 1202 one or more transporter information from one or more transporter devices associated with one or more transporters.

Further, the method 1000 may include a step 1008 of analyzing, using the processing device 1204, the one or more farm product information, the one or more processing centre information and the one or more transporter information.

Further, the method 1000 may include a step 1010 of generating, using the processing device 1204, one or more destination information based on analyzing of the one or more farm product information, the one or more processing centre information, and the one or more transporter information.

Further, the method 1000 may include a step 1012 of storing, using the storage device 1206, the one or more farm product information, the one or more processing centre information, and the one or more transporter information in the distributed ledger.

Further, the method 1000 may include a step 1014 of transmitting, using the communication device 1202, the one or more destination information to the one or more farmer devices.

Further, the method 1000 may include a step 1016 of transmitting, using the communication device 1202, the one or more transporter information to the one or more processing centre owner devices.

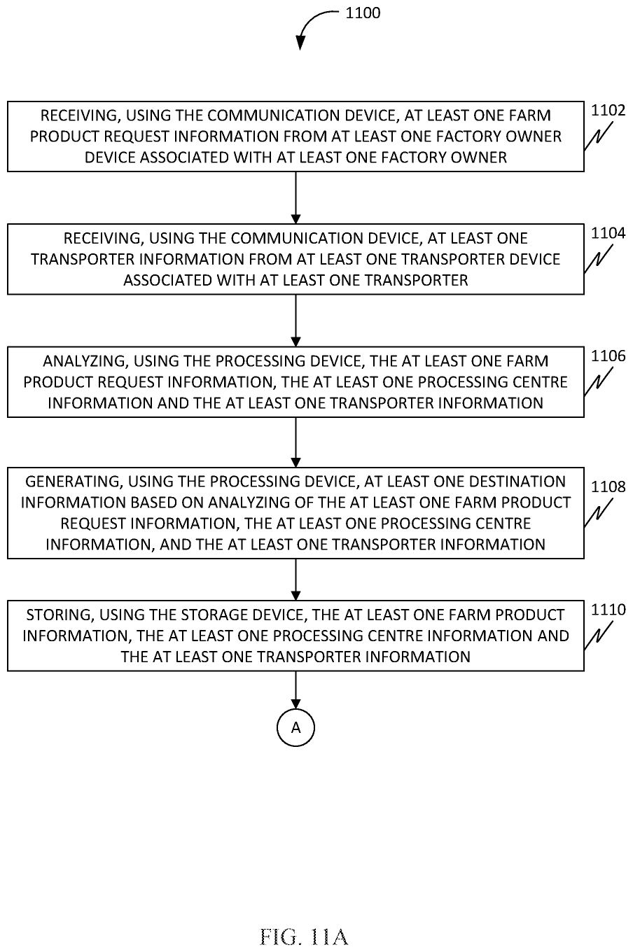

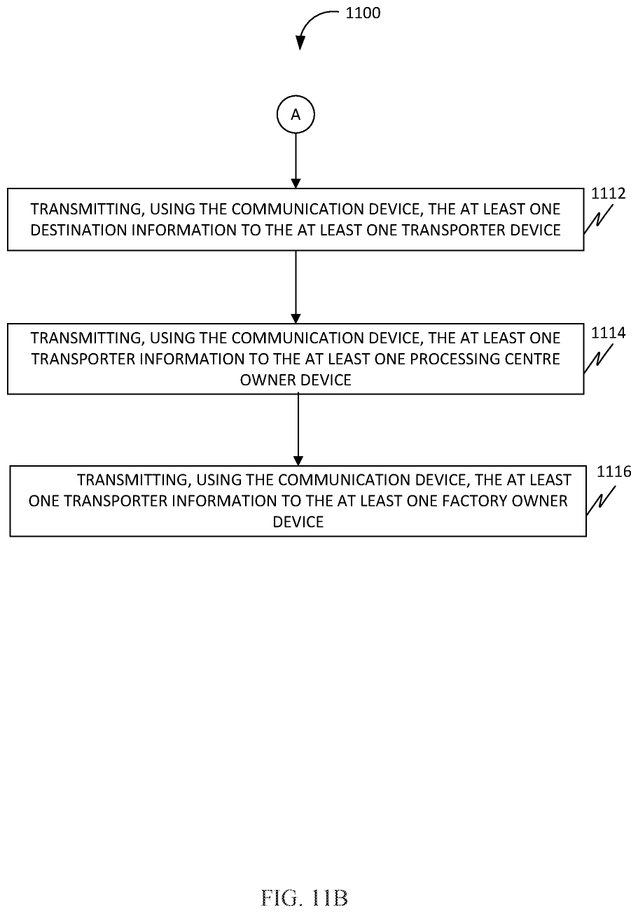

FIG. 11A and FIG. 11B illustrate a flowchart of a method 1100 of facilitating provisioning of an improved farming ecosystem, in accordance with some embodiments.

Further, the method 1100 may include a step 1102 of receiving, using the communication device 1202, at least one farm product request information from at least one factory owner device associated with one or more factory owners.

Further, the method 1100 may include a step 1104 of receiving, using the communication device 1202, one or more transporter information from one or more transporter devices associated with one or more transporters.

Further, the method 1100 may include a step 1106 of analyzing, using the processing device 1204, the at least one farm product request information, the one or more processing centre information, and the one or more transporter information.

Further, the method 1100 may include a step 1108 of generating, using the processing device 1204, one or more destination information based on the analyzing of the one or more farm product request information, the one or more processing centre information, and the one or more transporter information.

Further, the method 1100 may include a step 1110 of storing, using the storage device 1206, the one or more farm product information, the one or more processing centre information, and the one or more transporter information.

Further, the method 1100 may include a step 1112 of transmitting, using the communication device 1202, the one or more destination information to the one or more transporter devices.

Further, the method 1100 may include a step 1114 of transmitting, using the communication device 1202, the one or more transporter information to the one or more processing centre owner devices.

Further, the method 1100 may include a step 1116 of transmitting, using the communication device 1202, the one or more transporters information to the one or more factory owner devices.

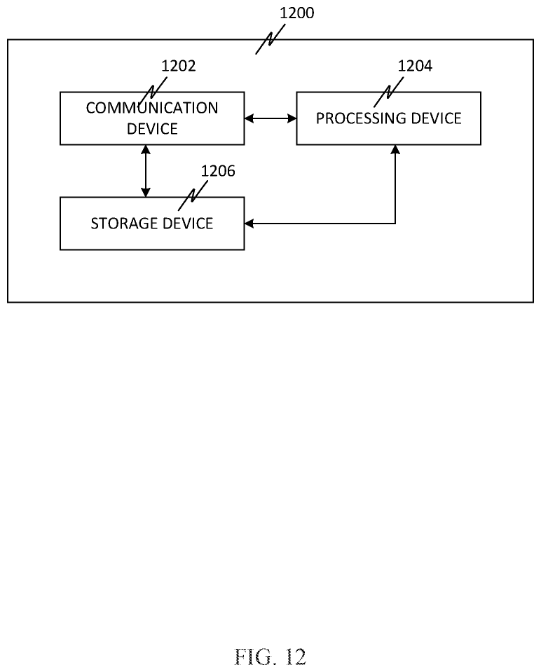

FIG. 12 illustrates a block diagram of a system 1200 of facilitating provisioning of an improved farming ecosystem, in accordance with some embodiments.

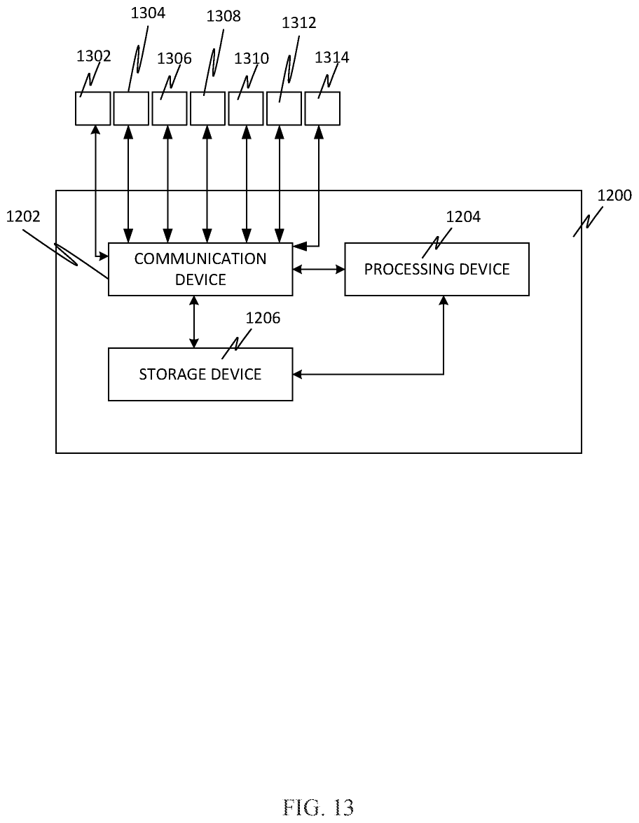

Accordingly, the system 1200 may include a communication device 1202. Further, the communication device 1202 may be configured for receiving one or more IOT information from one or more farmer devices 1302 (as shown in FIG. 13) associated with one or more farmers. Further, the communication device 1202 may be configured for transmitting one or more research data to the one or more farmer devices 1302. Further, the system 1200 may include a processing device 1204. Further, the processing device 1204 may be configured for analyzing the one or more IOT information. Further, the processing device 1204 may be configured for generating the one or more research data based on analyzing of the one or more IOT information. Further, the system 1200 may include a storage device 1206 configured for storing the one or more IoT information and the one or more research data in a distributed ledger. Further, the processing device 1204 may be communicatively coupled with the communication device 1202 and the storage device 1206.

Further, in some embodiments, the communication device 1202 may be configured for receiving at least one IOT request information from the at least one farmer device 1302 associated with at least one farmer. Further, the communication device 1202 may be configured for transmitting at least one order information to at least one transporter device 1308 (as shown in FIG. 13) associated with at least one transporter. Further, the communication device 1202 may be configured for receiving at least one transporter information from the at least one transporter device 1308. Further, the communication device 1202 may be configured for transmitting at least one notification information to the at least one farmer device 1302. Further, the processing device 1204 may be configured for generating the at least one order information based on the at least one IOT request information. Further, the processing device 1204 may be configured for generating the at least one notification information based on the at least one order request and the at least one transporter information. Further, the storage device 1206 may be configured for storing the at least one IOT information in the distributed ledger.

In some embodiments, the communication device 1202 may be configured for receiving one or more farm information from the one or more farmer devices 1302. Further, the storage device 1206 may be configured for retrieving one or more scientific research data from the distributed ledger. Further, the processing device 1204 may be configured for analyzing the one or more farm information and the one or more scientific research data. Further, the generating of the research data is based on the analyzing of the at least one farm information and the at least one scientific research data.

Further, in some embodiments, the communication device 1202 may be configured for receiving one or more farmer information from the one or more farmer devices 1302. Further, the communication device 1202 may be configured for transmitting one or more user information to the one or more farmer devices 1302, wherein the processing device 1204 may be configured for generating the one or more user information based on the one or more farmer information. Further, the storage device 1206 may be configured for storing the one or more user information and the one or more farmer information in the distributed ledger.

Further, in some embodiments, the communication device 1202 may be configured for receiving one or more insurance request information from the one or more farmer devices 1302 associated with the one or more farmers. Further, the communication device 1202 may be configured for transmitting the one or more insurance request information to one or more insurance agent devices 1304 (as shown in FIG. 13) associated with one or more insurance agents. Further, the communication device 1202 may be configured for receiving one or more insurance information from the one or more insurance agent devices 1304. Further, the communication device 1202 may be configured for transmitting the one or more insurance information to the one or more farmer devices 1302, wherein the storage device 1206 may be configured for storing the one or more insurance request information and the one or more insurance information in the distributed ledger.

Further, in some embodiments, the communication device 1202 may be configured for receiving one or more loan request information from the one or more farmer devices 1302 associated with the one or more farmers. Further, the communication device 1202 may be configured for transmitting one or more loan order information to at least one loan provider device 1306 (as shown in FIG. 13) associated with one or more loan providers. Further, the communication device 1202 may be configured for receiving one or more loan approval information from the one or more loan provider devices 1306. Further, the communication device 1202 may be configured for transmitting the one or more loan approval information to the one or more farmer devices 1302, wherein the storage device 1206 may be configured for storing the one or more loan request information and the one or more loan approval information in the distributed ledger.

Further, in some embodiments, the communication device 1202 may be configured for receiving one or more transporter information from at least one transporter device 1308. Further, the communication device 1202 may be configured for receiving one or more farm product information from the one or more farmer devices 1302. Further, the communication device 1202 may be configured for receiving one or more farm product request information from one or more factory owner devices 1310 (as shown in FIG. 13) associated with one or more factory owners. Further, the communication device 1202 may be configured for transmitting one or more destination information to the one or more transporter devices 1308. Further, the communication device 1202 may be configured for transmitting one or more transporter information to the one or more farmer devices 1302. Further, the communication device 1202 may be configured for transmitting the one or more transporter information to the one or more factory owner devices 1310. Further, the processing device 1204 may be configured for analyzing the one or more farm product information and the one or more farm product request information. Further, the processing device 1204 may be configured for generating the one or more destination information based on the analyzing of the one or more farm product information and the one or more farm product request information. Further, the storage device 1206 may be configured for storing the one or more destination information, the one or more farm product information, the one or more transporter information and the one or more farm product request information in the distributed ledger.

Further, in some embodiments, the communication device 1202 may be configured for receiving one or more product request information from at least one consumer device 1312 (as shown in FIG. 13) associated with one or more consumers.

Further, the communication device 1202 may be configured for receiving one or more product information from the one or more factory owner devices 1310 associated with one or more factory owners.

Further, the communication device 1202 may be configured for receiving one or more transporter information from one or more transporter devices 1308 associated with one or more transporters.

Further, the communication device 1202 may be configured for transmitting one or more order information to the one or more factory owner devices 1310.

Further, the communication device 1202 may be configured for transmitting one or more destination information to one or more transporter devices 1308 associated with one or more transporters.

Further, the communication device 1202 may be configured for transmitting one or more transporter information to the least one factory owner device 1310.

Further, the communication device 1202 may be configured for transmitting at least one notification information to the at least one consumer device 1312.

Further, the processing device 1204 may be configured for generating the one or more order information based on the one or more product request information. Further, the processing device 1204 may be configured for generating the one or more destination information based on analyzing of the one or more product request information and the one or more product information. Further, the processing device 1204 may be configured for generating the at least one notification information based on the at least one product information and the at least one transporter information. Further, the storage device 1206 may be configured for storing the at least one product request information, the at least one product information, and the at least one transporter information in the distributed ledger.

Further, in some embodiments, the communication device 1202 may be configured for receiving one or more farm product information from one or more farmer devices 1302 associated with one or more farmers. Further, the communication device 1202 may be configured for receiving one or more processing centre owner information from one or more processing centre owner devices 1314 (as shown in FIG. 13) associated with one or more processing centre owners.

Further, the communication device 1202 may be configured for receiving one or more transporter information from the one or more transporter devices 1308 associated with one or more transporters.

Further, the communication device 1202 may be configured for transmitting one or more destination information to the one or more transporter devices 1308.

Further, the communication device 1202 may be configured for transmitting the one or more transporter information to the one or more processing centre owner devices 1314.

Further, the communication device 1202 may be configured for transmitting one or more transporter information to the one or more farmer devices 1302.

Further, the processing device 1204 may be configured for analyzing the one or more farm product information, the one or more processing centre information, and the one or more transporter information. Further, the processing device 1204 may be configured for generating the one or more destination information based on analyzing of the one or more farm product information, the one or more processing centre information, and the one or more transporter information, wherein the storage device 1206 may be configured for storing the one or more farm product information, the one or more processing centre information, and the one or more transporter information in the distributed ledger.

Further, in some embodiments, the communication device 1202 may be configured for receiving one or more farm product request information from the at least one factory owner device 1310 associated with one or more factory owners.

Further, the communication device 1202 may be configured for receiving one or more processing centre information from one or more processing centre owner devices 1314 associated with one or more processing centre owners.

Further, the communication device 1202 may be configured for receiving one or more transporter information from the one or more transporter devices 1308 associated with one or more transporters.

Further, the communication device 1202 may be configured for transmitting one or more destination information to the one or more transporter devices 1308.

Further, the communication device 1202 may be configured for transmitting the one or more transporter information to the one or more processing centre owner devices 1314.

Further, the communication device 1202 may be configured for transmitting at least one transporter information to the at least factory owner device 1310.

Further, the processing device 1204 may be configured for analyzing the one or more farm product request information, the one or more processing centre information, and the one or more transporter information.

Further, the processing device 1204 may be configured for generating the one or more destination information based on analyzing of the one or more farm product request information, the one or more processing centre information, and the one or more transporter information, wherein the storage device 1206 may be configured for storing the one or more farm product information, the one or more processing centre information, and the one or more transporter information.

FIG. 13 illustrates a block diagram of the system 1200 of facilitating provisioning of an improved farming ecosystem, in accordance with some embodiments.

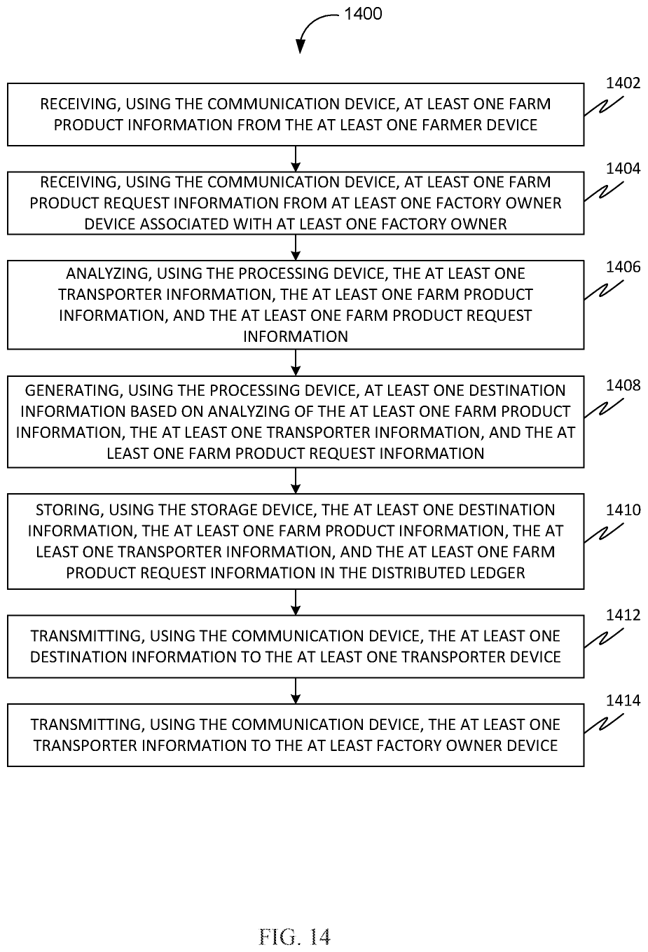

FIG. 14 illustrates a flowchart of a method 1400 of facilitating provisioning of an improved farming ecosystem, in accordance with some embodiments. Accordingly, the method 1400 may include a step 1402 of receiving, using the communication device 1202, at least one farm product information from the at least one farmer device.

Further, the method 1400 may include a step 1404 of receiving, using the communication device 1202, at least one farm product request information from at least one factory owner device associated with at least one factory owner.

Further, the method 1400 may include a step 1406 of analyzing, using the processing device 1204, the at least one transporter information, the at least one farm product information, and the at least one farm product request information.

Further, the method 1400 may include a step 1408 of generating, using the processing device 1204, at least one destination information based on analyzing of the at least one farm product information, the at least one transporter information, and the at least one farm product request information.

Further, the method 1400 may include a step 1410 of storing, using the storage device 1206, the at least one destination information, the at least one farm product information, the at least one transporter information, and the at least one farm product request information in the distributed ledger.

Further, the method 1400 may include a step 1412 of transmitting, using the communication device 1202, the at least one destination information to the at least one transporter device.

Further, the method 1400 may include a step 1414 of transmitting, using the communication device 1202, the at least one transporter information to the at least factory owner device.

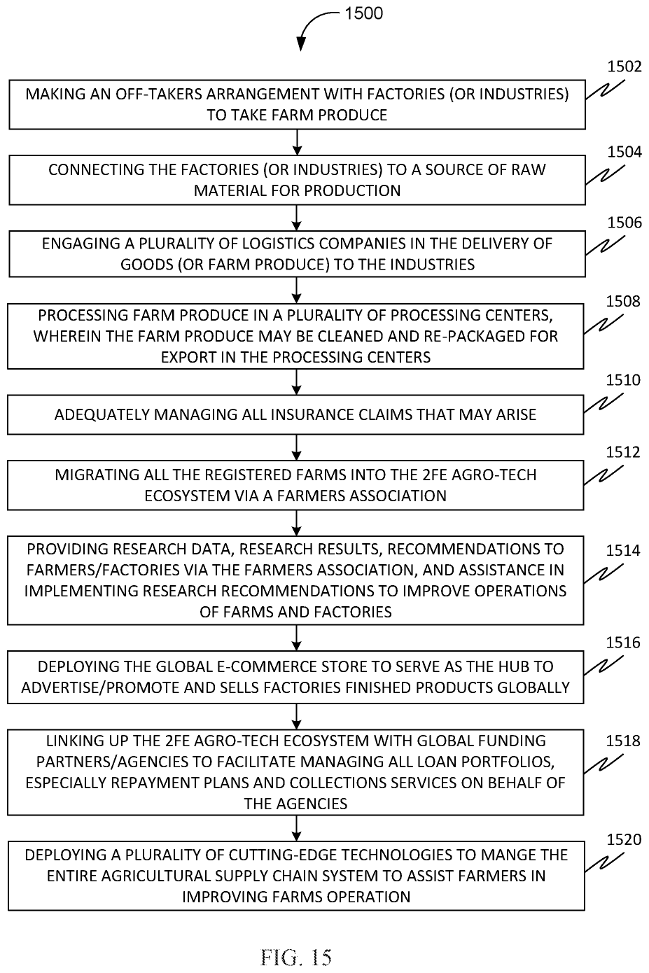

FIG. 15 is a flowchart of a method 1500 for facilitating business operations associated with the 2FE agro-tech ecosystem, in accordance with some embodiments.

Further, at 1502, the method 1500 may include a step of making an off-takers arrangement with factories (or industries) to take farm produce. Further, a plurality of farmers (or farmers) may be supported with a plurality of cutting-edge technologies to improve and manage farm inventory/records. Further, the plurality of cutting-edge technologies may include IoT systems & drone technologies to improve & increase farm yields. Further, the plurality of farmers may be supported with research data & research information. Further, the plurality of farmers may be supported to get access to loans and business grants. Furthermore, blockchain technologies may be used to monitor/track farm produce and export transactions.

Further, at 1504, the method 1500 may include a step of connecting the factories (or industries) to a source of raw material for production, wherein the raw materials may be delivered directly to the factories. Further, a global e-commerce market store may be created and finished products of the factories may be advertised and promoted through digital marketing tools. Further, the factories may be facilitated to be granted loans/business with funding partners and agencies to improve production. Further, the factories may be helped with research data and information.

Further, at 1506, the method 1500 may include a step of engaging a plurality of logistics companies in the delivery of goods (or farm produce) to the industries. Further, the goods in transit may be monitored, tracked, and managed from the source down to the destination.

Further, at 1508, the method 1500 may include a step of processing farm produce in a plurality of processing centers, wherein the farm produce may be cleaned and re-packaged for export in the plurality of processing centers. Further, the perishable goods may be preserved and managed in the processing centers, wherein a QA/QC department may oversee the quality/condition of goods before delivery to the destination.

Further, at 1510, the method 1500 may include a step of adequately managing all insurance claims that may arise.

Further, at 1512, the method 1500 may include a step of migrating all the registered farms into the 2FE agro-tech ecosystem via a farmers' association, wherein liaising with the farmers' association may improve the farm produce. Further, research information may be provided or communicated to farmers through the farmers' association. Further, the farmers' association may be provided with a business grant/loan accessible to information associated with farmers.

Further, at 1514, the method 1500 may include a step of providing research data, research results, recommendations to farmers/factories via the farmers' association, and assistance in implementing research recommendations to improve operations of farms and factories.

Further, at 1516, the method 1500 may include a step of deploying the global e-commerce store to serve as the hub to advertise/promote and sells factories finished products globally.

Further, at 1518, the method 1500 may include a step of linking up the 2FE agro-tech ecosystem with global funding partners/agencies to facilitate managing all loan portfolios, especially repayment plans and collections services on behalf of the agencies.

Further, at 1520, the method 1500 may include a step of deploying a plurality of cutting-edge technologies to manage the entire agricultural supply chain system to assist farmers in improving farm's operations. Further, the plurality of cutting-edge technologies may include blockchain technologies to store/track the conditions of goods. Further, administrative software may manage the entire global e-commerce website that may include a global market hub to showcase and sells the finished products of the factories. Further, IoT systems & drones may be deployed to assist farmers in performing farm operations. Further, mobile apps on the iOS and Android may be available for transactions and tracking operations.

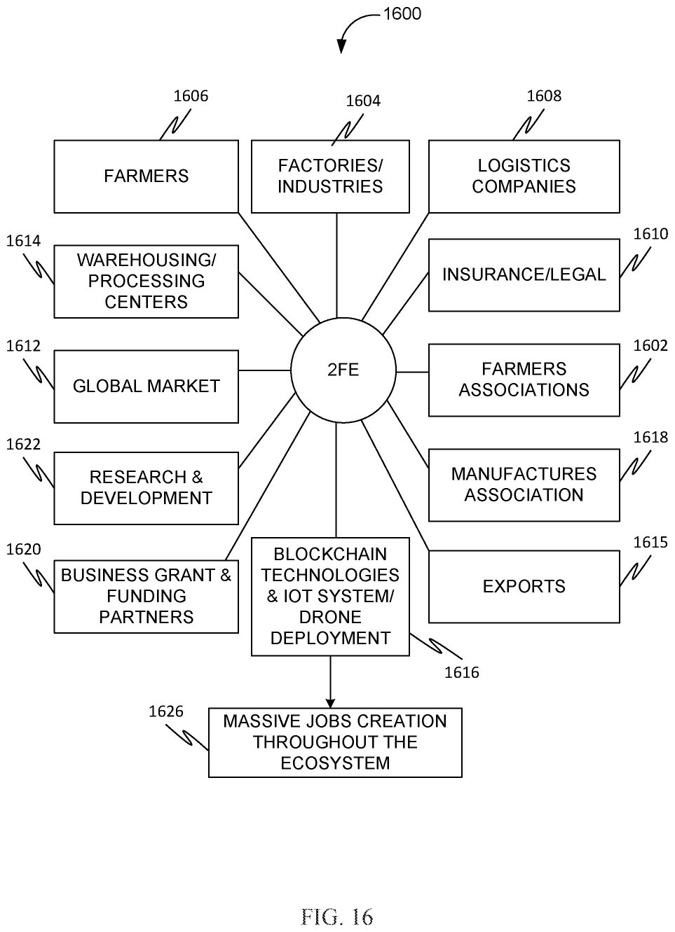

FIG. 16 illustrates the 2FE agro-tech ecosystem 1600, in accordance with some embodiments. Further, the 2FE agro-tech ecosystem 1600 may include a plurality of components 1602-1622. Further, the plurality of components 1602-1622 may include the farmers' association 1602, the factories 1604, the plurality of farmers 1606, the plurality of logistics companies 1608, insurance institutions 1610, the global e-commerce market 1612, the plurality of warehousing/processing centers 1614, the plurality of cutting-edge technologies 1616 (such as blockchain technologies, IOT system, and drone deployment), manufacturers associations 1618, funding partners and agencies 1620, etc. Further, the 2FE agro-tech ecosystem 1600 may create a plurality of jobs 1626 throughout the ecosystem 1600. Further, at 1615, the 2FE agro-tech ecosystem 1600 may be configured to facilitate exporting of the goods. Further, at 1622, the 2FE agro-tech ecosystem 1600 may be configured to facilitate research and development.

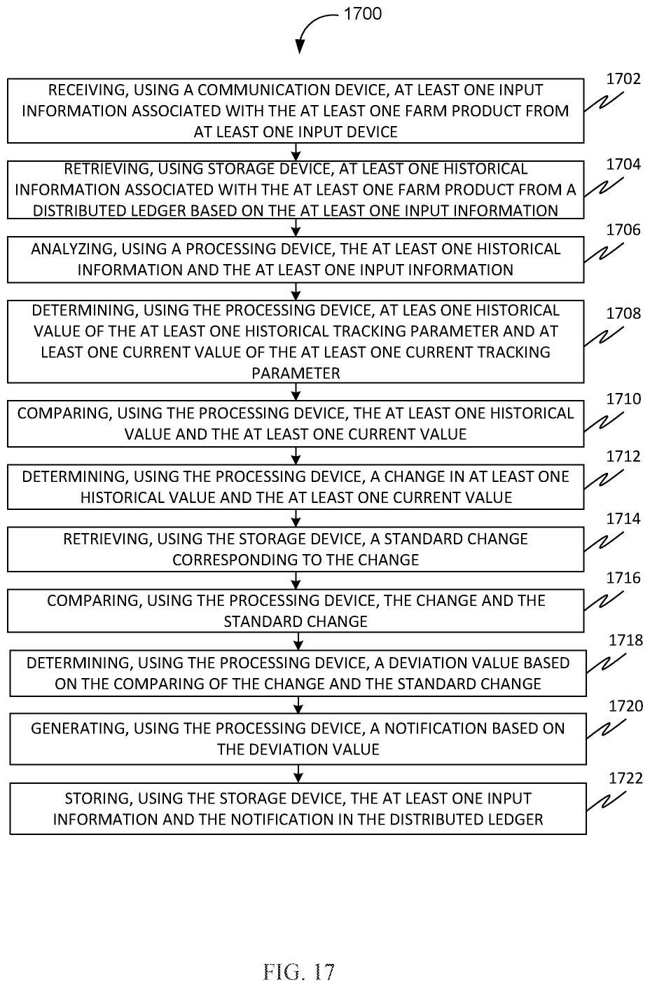

FIG. 17 is a flowchart of a method 1700 for tracking and monitoring at least one farm product associated with the 2FE agro-tech ecosystem, in accordance with some embodiments.

Further, at 1702, the method 1700 may include a step of receiving, using a communication device (such as the communication device 1202), at least one input information associated with the at least one farm product from at least one input device. Further, the at least one input device may include a scanning device, a microphone, a keypad, etc. Further, the at least one input device may be configured for allowing an individual to perform at least one input action. Further, the at least one input action may include scanning a code associated with the at least one farm product, typing a password associated with the at least one farm product, etc. Further, the at least one input device may be configured for generating the at least one input information based on the at least one input action. Further, the at least one input information may include at least one current tracking parameter. Further, the at least one input information may include a time, a location, an employee identification, mode of transportation, transportation vehicle identification, etc. Further, the at least one current tracking parameter may include the time, the location, etc.

Further, at 1704, the method 1700 may include a step of retrieving, using a storage device (such as the storage device 1206), at least one historical information associated with the at least one farm product from a distributed ledger based on the at least one input information. Further, the at least one historical information may include a historical time, a historical location, a historical employee identification, a historical mode of transportation, historical transportation vehicle identification, etc. Further, the at least one input action associated with the at least one historical information may be performed before the at least one input action associated with the at least one input information. Further, the at least one historical information may include at least one historical tracking parameter. Further, the at least one historical tracking parameter may include the historical time, the historical location, etc.

Further, at 1706, the method 1700 may include a step of analyzing, using a processing device (such as the processing device 1204), the at least one historical information and the at least one input information.

Further, at 1708, the method 1700 may include a step of determining, using the processing device, at least one historical value of the at least one historical tracking parameter and at least one current value of the at least one current tracking parameter. Further, the at least one historical value may include a specific time in the past, a previous place in the path of the at least one farm product, etc. Further, the at least one current value may include a specific time in the present, a specific location of the at least one farm product in the present, etc.

Further, at 1710, the method 1700 may include a step of comparing, using the processing device, the at least one historical value and the at least one current value.

Further, at 1712, the method 1700 may include a step of determining, using the processing device, a change in at least one historical value and the at least one current value. Further, the change may reflect an actual difference between the at least one historical value and the at least one current value.

Further, at 1714, the method 1700 may include a step of retrieving, using the storage device, a standard change corresponding to the change. Further, the standard change may reflect the most expected difference between the at least one historical value and the at least one current value.

Further, at 1716, the method 1700 may include a step of comparing, using the processing device, the change and the standard change.

Further, at 1718, the method 1700 may include a step of determining, using the processing device, a deviation value based on the comparing of the change and the standard change. Further, the deviation value may reflect the deviation between the change and the standard change.

Further, at 1720, the method 1700 may include a step of generating, using the processing device, a notification based on the deviation value.

Further, at 1722, the method 1700 may include a step of storing, using the storage device, the at least one input information and the notification in the distributed ledger.

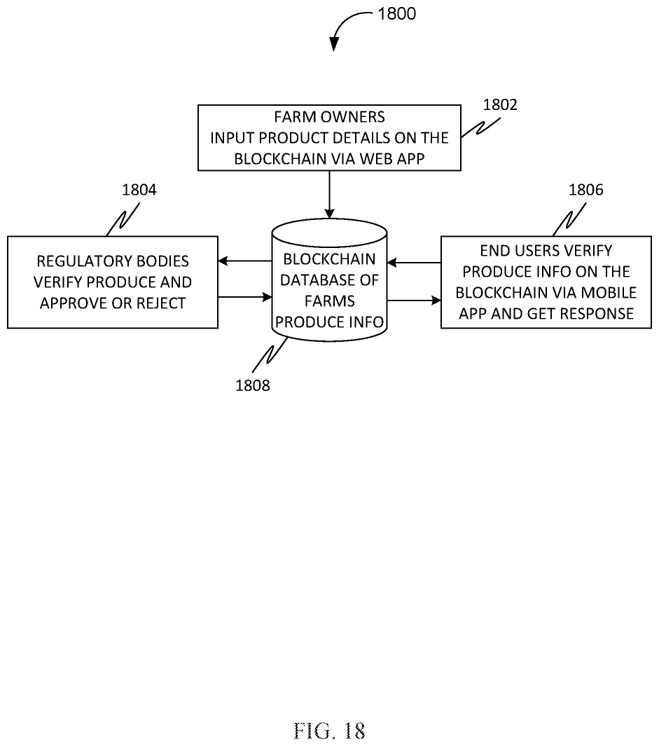

FIG. 18 illustrates an architecture of a system 1800 for facilitating provisioning of an improved farming ecosystem, in accordance with some embodiments. Accordingly, the system 1800 may include a blockchain database 1808 of farm produce information associated with a farm produce. Further, at 1802, farm owners may input product details on the blockchain database 1808 via a web application. Further, at 1804, regulatory bodies may verify the farm produce and approve or reject the farm produce. Further, at 1806, end users may verify the farm produce information on the blockchain database 1808 via a mobile application and receive a response.

Although the invention has been explained in relation to its preferred embodiment, it is to be understood that many other possible modifications and variations can be made without departing from the spirit and scope of the invention as hereinafter claimed.

What is claimed is:

1. A method of facilitating provisioning of an improved farming ecosystem, the method comprising;
receiving, using a communication device, at least one IOT information from at least one farmer device associated with at least one farmer;
analyzing, using a processing device, the at least one IOT information;
generating, using the processing device, at least one research data based on the analyzing of the at least one IOT information;
storing, using a storage device, the at least one IOT information and the at least one research data in a distributed ledger, and
transmitting, using the communication device, the at least one research data to the at least one farmer device.

2. The method of claim 1, wherein the method further comprises:
receiving, using the communication device, at least one IOT request information from the at least one farmer device associated with the at least one farmer;
storing, using the storage device, the at least one IOT request information in the distributed ledger;
generating, using the processing device, at least one order information based on the at least one IOT request information;
transmitting, using the communication device, the at least one order information to at least one transporter device associated with at least one transporter;
receiving, using the communication device, at least one transporter information from the at least one transporter device;
generating, using the processing device, at least one notification information based on the at least one order request and the at least one transporter information; and
transmitting, using the communication device, the at least one notification information to the at least one farmer device.

3. The method of claim 1, wherein the method further comprises:
receiving, using the communication device, at least one farm information from the at least one farmer device associated with the at least one farmer;
retrieving, using the storage device, at least one scientific research data from the distributed ledger based on the at least one farm information; and
analyzing, using the processing device, the at least one farm information and the at least one scientific research data, wherein the generating of the research data is further based on the analyzing of the at least one farm information and the at least one scientific research data.

4. The method of claim 1, wherein the method further comprises:
receiving, using the communication device, at least one farmer information from the at least one farmer device associated with the at least one farmer;
generating, using the processing device, at least one user information based on the at least one farmer information;
storing, using the storage device, the at least one user information and the at least one farmer information in the distributed ledger; and
transmitting, using the communication device, the at least one user information to the at least one farmer device.

5. The method of claim 4, wherein the method further comprises:
receiving, using the communication device, at least one insurance request information from the at least one farmer device associated with the at least one farmer;
transmitting, using the communication device, the at least one insurance request information to at least one insurance agent device associated with at least one insurance agent;
receiving, using the communication device, at least one insurance information from the at least one insurance agent device;
storing, using the storage device, the at least one insurance request information and the at least one insurance information in the distributed ledger; and
transmitting, using the communication device, the at least one insurance information to the at least one farmer device.

6. The method of claim 4, wherein the method further comprises:
receiving, using the communication device, at least one loan request information from the at least one farmer device associated with the at least one farmer;
generating, using the processing device, at least one loan order information based on the at least one loan request;
transmitting, using the communication device, the at least one loan order information to at least one loan provider device associated with at least one loan provider;
receiving, using the communication device, at least one loan approval information from the at least one loan provider device;
storing, using the storage device, the at least one loan request information and the at least one loan approval information in the distributed ledger; and
transmitting, using the communication device, the at least one loan approval information to the at least one farmer device.

7. The method of claim 2, wherein the method further comprising;
receiving, using the communication device, at least one farm product information from the at least one farmer device;
receiving, using the communication device, at least one farm product request information from at least one factory owner device associated with at least one factory owner;
analyzing, using the processing device, the at least one transporter information, the at least one farm product information, and the at least one farm product request information;
generating, using the processing device, at least one destination information based on analyzing of the at least one farm product information, the at least one transporter information, and the at least one farm product request information;
storing, using the storage device, the at least one destination information, the at least one farm product information, the at least one transporter information, and the at least one farm product request information in the distributed ledger;
transmitting, using the communication device, the at least one destination information to the at least one transporter device; and
transmitting, using the communication device, the at least one transporter information to the at least factory owner device.

8. The method of claim 1, wherein the method further comprises:
receiving, using the communication device, at least one product request information from at least one consumer device associated with at least one consumer;
receiving, using the communication device, at least one product information from at least one factory owner device associated with at least one factory owner;
receiving, using the communication device, at least one transporter information from at least one transporter device associated with at least one transporter;
generating, using the processing device, at least one order information based on the at least one product request information;
transmitting, using the communication device, the at least one order information to the at least one factory owner device;
analyzing, using the processing device, the at least one product request information and the at least one product information;
generating, using the processing device, at least one destination information based on analyzing the at least one product request information and the at least one product information;
transmitting, using the communication device, the at least one destination information to at least one transporter device associated with at least one transporter;
storing, using the storage device, the at least one product request information, the at least one product information, and the at least one transporter information in the distributed ledger;
generating, using the processing device, at least one notification based on the at least one product information and the at least one transporter information;
transmitting, using the communication device, the at least one transporter information to the at least one factory owner device; and
transmitting, using the communication device, the at least one notification to the at least one consumer device.

9. The method of claim 4, wherein the method further comprises:
receiving, using the communication device, at least one farm product information from the at least one farmer device associated with the at least one farmer;
receiving, using the communication device, at least one processing centre information from at least one processing centre owner device associated with at least one processing centre owner;
receiving, using the communication device at least one transporter information from at least one transporter device associated with at least one transporter;
analyzing, using the processing device, the at least one farm product information, the at least one processing centre information and the at least one transporter information;
generating, using the processing device, at least one destination information based on analyzing of the at least one farm product information, the at least one processing centre information and the at least one transporter information;
storing, using the storage device, the at least one farm product information, the at least one processing centre information, and the at least one transporter information in the distributed ledger;
transmitting, using the communication device, the at least one destination information to the at least one farmer device, and
transmitting, using the communication device, the at least one transporter information to the at least one processing centre owner device.

10. The method of claim 9, wherein the method further comprises:
receiving, using the communication device, at least one farm product request information from at least one factory owner device associated with at least one factory owner;
receiving, using the communication device, at least one transporter information from at least one transporter device associated with at least one transporter;
analyzing, using the processing device, the at least one farm product request information, the at least one processing centre information, and the at least one transporter information;
generating, using the processing device, at least one destination information based on the analyzing of the at least one farm product request information, the at least one processing centre information and the at least one transporter information;
storing, using the storage device, the at least one farm product information, the at least one processing centre information, and the at least one transporter information;
transmitting, using the communication device, the at least one destination information to the at least one transporter device;
transmitting, using the communication device, the at least one transporter information to the at least one processing centre owner device, and
transmitting, using the communication device, the at least one transporter information to the at least one factory owner device.

11. A system for facilitating provisioning of an improved farming ecosystem, wherein the system comprises:
a communication device configured for:
receiving at least one IOT information from at least one farmer device associated with at least one farmer; and
transmitting at least one research data to the at least one farmer device;
a processing device is configured for:
analyzing the at least one IOT information; and
generating the at least one research data based on analyzing of the at least one IOT information; and
a storage device is configured for storing the at least one IOT information and the at least one research data in a distributed ledger.

12. The system of claim 11, wherein the communication device is further configured for:
receiving at least one IOT request information from at least one farmer device associated with at least one farmer;
transmitting at least one order information to at least one transporter device associated with at least one transporter;
receiving at least one transporter information from the at least one transporter device; and
transmitting at least one notification information to the at least one farmer device; and wherein the processing device is further configured for:
generating the at least one order information based on the at least one IOT request information; and
generating the at least one notification information based on the at least one order request and the at least one transporter information; and wherein the storage device is further configured for storing the at least one IOT information in the distributed ledger.

13. The system of claim 11, wherein the communication device is further configured for receiving at least one farm information from the at least one farmer device, wherein the storage device is further configured for retrieving at least one scientific research data from the distributed ledger, wherein the processing device is further configured for analyzing the at least one farm information and the at least one scientific research data, wherein the generating of the research data is further based on the analyzing of the at least one farm information and the at least one scientific research data.

14. The system of claim 11, wherein the communication device is further configured for:
receiving at least one farmer information from the at least one farmer device; and
transmitting at least one user information to the at least one farmer device, wherein the processing device is further configured for generating the at least one user information based on the at least one farmer information, wherein the storage device is further configured for storing the at least one user information and the at least one farmer information in the distributed ledger.

15. The system of claim 14, wherein the communication device is further configured for:
receiving at least one insurance request information from the at least one farmer device associated with the at least one farmer;
transmitting at least one insurance request information to at least one insurance agent device associated with at least one insurance agent;
receiving at least one insurance information from the at least one insurance agent device; and
transmitting the at least one insurance information to the at least one farmer device, wherein the storage device is further configured for storing the at least one insurance request information and the at least one insurance information in the distributed ledger.

16. The system of claim 14, wherein the communication device is further configured for:
receiving at least one loan request information from the at least one farmer device associated with the at least one farmer;
transmitting at least one loan order information to at least one loan provider device associated with at least one loan provider;
receiving at least one loan approval information from the at least one loan provider device; and
transmitting the at least one loan approval information to the at least one farmer device, wherein the storage device is further configured for storing the at least one loan request information and the at least one loan approval information in the distributed ledger.

17. The system of claim 12, wherein the communication device is further configured for:
receiving at least one transporter information from at least one transporter device;
receiving at least one farm product information from the at least one farmer device;
receiving at least one farm product request information from at least one factory owner device associated with at least one factory owner;
transmitting at least one destination information to the at least one transporter device;
transmitting at least one transporter information to the at least one farmer device; and
transmitting the at least one transporter information to the at least one factory owner device, wherein the processing device is further configured for:
analyzing the at least one farm product information and the at least one farm product request information; and
generating the at least one destination information based on the analyzing of the at least one farm product information and the at least one farm product request information, wherein the storage device is further configured for storing the at least one destination information, the at least one farm product information, the at least one transporter information and the at least one farm product request information in the distributed ledger.

18. The system of claim 11, wherein the communication device is further configured for:
receiving at least one product request information from at least one consumer device associated with at least one consumer;
receiving at least one product information from at least one factory owner device associated with at least one factory owner;
receiving at least one transporter information from at least one transporter device associated with at least one transporter;
transmitting at least one order information to the at least one factory owner device;
transmitting at least one destination information to at least one transporter device associated with at least one transporter;
transmitting at least one transporter information to the least one factory owner device; and
transmitting at least one notification information to the at least one consumer device, wherein the processing device is further configured for:
generating the at least one order information based on the at least one product request information;
generating the at least one destination information based on analyzing the at least one product request information and the at least one product information; and
generating the at least one notification information based on the at least one product information and the at least one transporter information, wherein the storage device is further configured for storing the at least one product request information, the at least one product information and the at least one transporter information in the distributed ledger.

19. The system of claim 14, wherein the communication device is further configured for:
receiving at least one farm product information from at least one farmer device associated with at least one farmer;
receiving at least one processing centre owner information associated with at least one processing centre owner;
receiving at least one transporter information from at least one transporter device associated with at least one transporter;
transmitting at least one destination information to the at least one transporter device;
transmitting the at least one transporter information to the at least one farmer device; and
transmitting at least one transporter information to the at least one processing centre owner device, wherein the processing device is further configured for:
analyzing the at least one farm product information, the at least one processing centre information and the at least one transporter information; and
generating the at least one destination information based on analyzing of the at least one farm product information, the at least one processing centre information and the at least one transporter information, wherein the storage device is further configured for storing the at least one farm product information, the at least one processing centre information, and the at least one transporter information in the distributed ledger.

20. The system of claim 19, wherein the communication device is further configured for:
receiving at least one farm product request information from at least one factory owner device associated with at least one factory owner;
receiving at least one processing centre information from at least one processing centre owner device associated with at least one processing centre owner;
receiving at least one transporter information from at least one transporter device associated with at least one transporter;
transmitting at least one destination information to the at least one transporter device;
transmitting the at least one transporter information to the at least one processing centre owner device; and
transmitting at least one transporter information to the at least one factory owner device, wherein the processing device is further configured for:
analyzing the at least one farm product request information, the at least one processing centre information, and the at least one transporter information; and
generating the at least one destination information based on analyzing of the at least one farm product request information, the at least one processing centre information, and the at least one transporter information, wherein the storage device is further configured for storing the at least one farm product information, the at least one processing centre information and the at least one transporter information.
